(19) United States
(12) Patent Application Publication
(10) Pub. No.: US 2014/0366321 A1
(43) Pub. Date: Dec. 18, 2014

(54) Hinge Connector for Foldable Door

(71) Applicant: Chang-Than Chen, Kaohsiung City (TW)

(72) Inventor: Chang-Than Chen, Kaohsiung City (TW)

(21) Appl. No.: 13/920,124

(22) Filed: Jun. 18, 2013

(51) Int. Cl. E05D 7/00; E05D 1/02

(52) U.S. Cl. CPC E05D 7/009; E05D 1/02
USPC 16/225

(57) ABSTRACT

A hinge connector for a foldable door includes a board body, a protruding column and two flexible pivotal strips. The foldable door includes a plurality of door panels, and a longitudinal groove with an opening is disposed in each of two lateral sides of each door panel. The protruding column is protruded outwardly from an inner surface of the board body and includes two inwardly inclined side faces and an inner end face. Each pivotal strip is extended outwardly from one of the side faces of the protruding column and includes an enlarged connecting head formed on a terminal thereof. Each pivotal strip of the hinge connector is adapted to be engaged in the opening of an associated groove of a corresponding door panel with the connecting head of each pivotal strip engaged in the associated groove of the corresponding door panel.

### BACKGROUND OF THE INVENTION

The present invention relates to a hinge connector for a foldable door and, more particularly, to a hinge connector structure adapted to be mounted between two door panels of the foldable door, allowing the door panels of the foldable door to be folded relative to each other.

FIG. 1 shows a conventional foldable door which includes a plurality of door panels 10. A flexible hinge connector 11 is connected between two adjacent door panels 10 and includes two pivotal rods 13 disposed on two lateral sides thereof respectively. A longitudinal groove 12 is disposed in each of two lateral sides of each door panel 10. Each pivotal rod 13 of the hinge connector 11 is inserted into an associated groove 12 of a corresponding door panel 10 from the top so that the two adjacent door panels 10 can be turned pivotally relative to each other by the flexibility of the hinge connector 11. Thus, the foldable door can be folded or unfolded conveniently. However, because the hinge connectors 11 are formed as sheets, the pivotal rods 13 may easily slide and disengage from the grooves 12 and lose the connecting function when the door panels 10 are being pushed and pulled. Furthermore, when the door panels 10 are folded together, because the hinge connectors 11 are formed as sheets, the door panels 10 cannot be folded and arranged in contact with each other, as shown in FIG. 2. As a result, the folded foldable door has a larger width which will adversely affect the convenience of people passing through. Additionally, when the foldable door is folded, it looks awkward because the hinge connectors 11 are protruded outside, and the thin protruded hinge connectors 11 can easily get damaged from impact and friction.

FIG. 3 shows another type of conventional foldable door with a larger size and door panels with a large width. A hinge connector 20 of the foldable door is in the form of a vertical column with rough T-shaped cross sections. C-shaped grooves 21 are disposed in two lateral sides of the hinge connector 20 respectively. Each door panel 22 of the foldable door includes two pivots 23 formed on two lateral sides thereof respectively. Each of the pivots 23 is engaged in an associated C-shaped groove 21 of the hinge connector 20 so that the door panels 22 can be turned pivotally about the pivots 23. Thereby, the door panels 22 can be folded or unfolded. However, because the turning of the pivots 23 will rub against the C-shaped grooves 21 in full area contact, it will not be smooth when the door panels 22 are being pushed or pulled, and larger noise will be produced due to the friction in full area contact.

### BRIEF SUMMARY OF THE INVENTION

It is an objective of the present invention to provide a hinge connector for a foldable door for improving the problems of easy disengagement and producing noise in conventional foldable doors. Thereby, the effectiveness of the hinge connector can be enhanced and the foldable door will look more aesthetically appealing.

To achieve this and other objectives, a hinge connector of the present invention is adapted for connecting two adjacent door panels of a foldable door to allow the door panels to be folded or unfolded. Each door panel includes a longitudinal groove with an opening formed in each of two lateral sides thereof. The hinge connector includes a board body, a protruding column, and two flexible pivotal strips. The board body includes two spaced side ends and an inner surface. The protruding column is protruded outwardly from the inner surface of the board body and includes two inwardly inclined side faces and an inner end face connecting the two side faces. The side faces of the protruding column are respectively spaced from the side ends of the board body, and the inner surface of the board body includes two pressing portions defined on two sides of the protruding column. Each pivotal strip is extended outwardly from one of the side faces of the protruding column and includes an enlarged connecting head formed on a terminal thereof. Each of the pivotal strips of the hinge connector is adapted to be engaged in the opening of an associated groove of a corresponding door panel, with the connecting head of each pivotal strip engaged in the associated groove of the corresponding door panel. Outer surfaces of the door panels are pressed against the pressing portions of the hinge connector respectively when the door panels of the foldable door are unfolded, while inner ends of the two door panels are pressed against the inner end face of the protruding column respectively when the door panels of the foldable door are folded.

In a preferred form, each pivotal strip is at an inclined angle of 30 to 60 degrees relative to the inner surface of the board body.

Preferably, each pivotal strip is at an inclined angle of 45 degrees relative to the inner surface of the board body.

The present invention will become clearer in light of the following detailed description of an illustrative embodiment of this invention described in connection with the drawings.

### DESCRIPTION OF THE DRAWINGS

FIG. 1 is schematic view of a conventional foldable door.

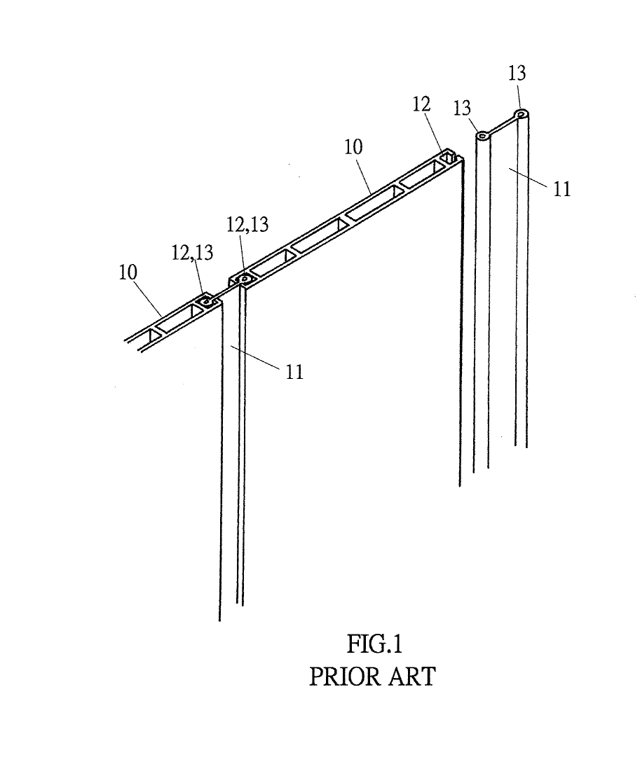

FIG. 2 is a schematic view of the foldable door of FIG. 1 being folded.

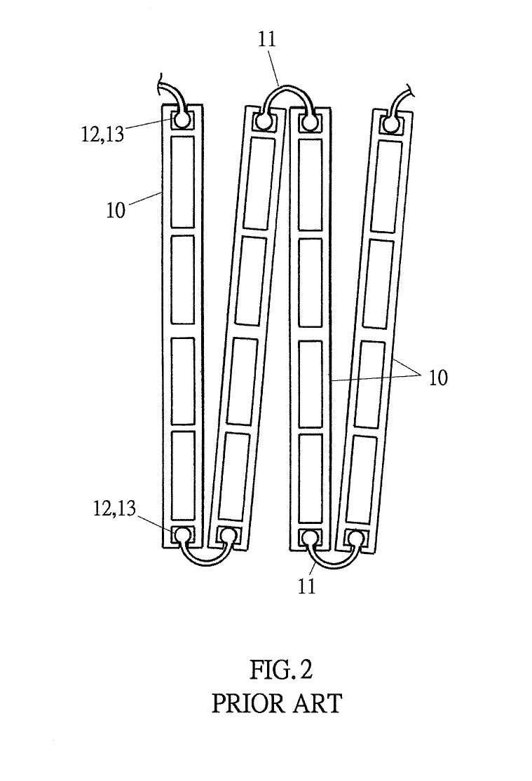

FIG. 3 is a schematic view of another conventional foldable door.

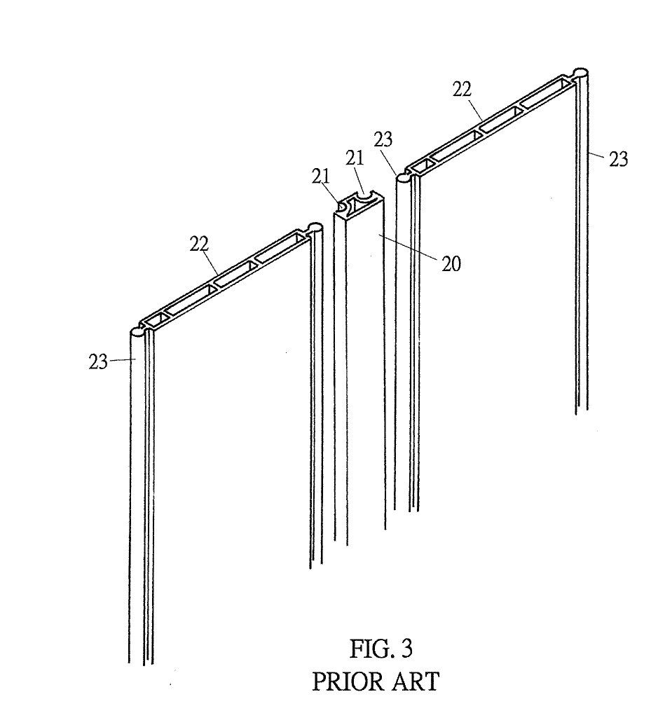

FIG. 4 is a perspective, schematic view of a hinge connector according to the present invention and two door panels of a foldable door, with a partial enlarged view of the hinge connector.

FIG. 5 shows an assembly schematic view of a plurality of hinge connectors according to the present invention applied in the foldable door.

FIG. 6 shows a schematic view of the hinge connector of FIG. 4 assembled between two unfolded door panels.

FIG. 7 shows a schematic view of the two door panels of FIG. 6 being folded.

### DETAILED DESCRIPTION OF THE INVENTION

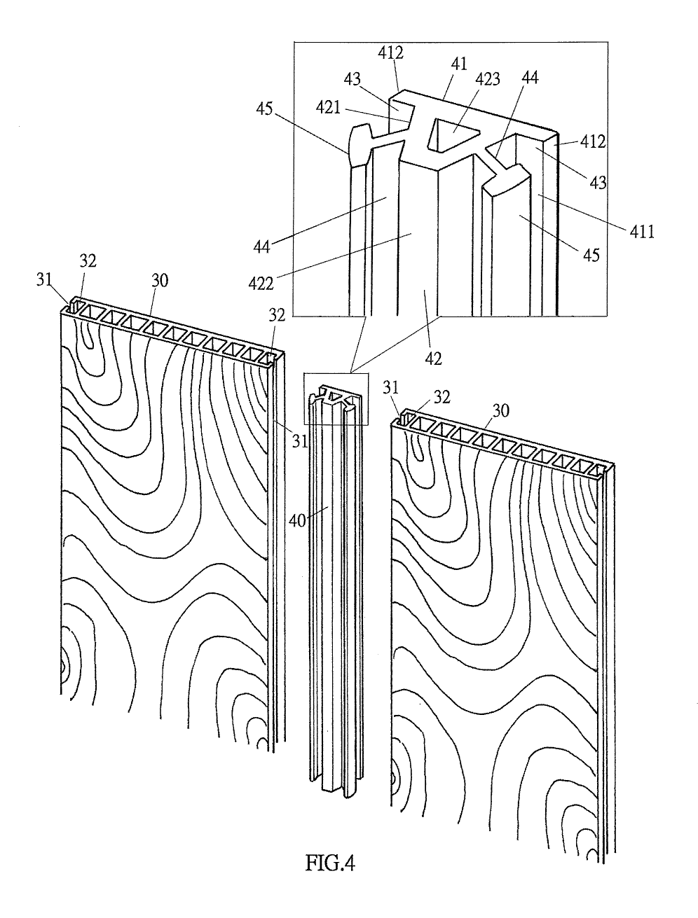

A hinge connector according to an embodiment of the present invention is shown in FIGS. 4 through 7 of the drawings and generally designated 40. The hinge connector 40 is adapted for connecting between two adjacent door panels 30 of a foldable door. Each door panel 30 is a long plate and includes a longitudinal groove 32 with an opening 31 formed in each of two lateral sides thereof. Specific colors (a single color or a combination of colors), grains (wood grain or stone grain) or patterns (cartoons or geometric drawings) can be provided on surfaces of the door panel 30 by spraying, printing, or other means of painting.

The hinge connector 40 includes a board body 41, a protruding column 42, and two flexible pivotal strips 44. The board body 41 includes two spaced side ends 412 and an inner surface 411 connected between the side ends 412. The protruding column 42 is protruded outwardly from a central portion of the inner surface 411 of the board body 41 and has rough trapezoidal cross sections. The protruding column 42 has two inwardly inclined side faces 421 and an inner end face 422 connecting the two side faces 421. A longitudinal channel 423 is formed in the protruding column 42 for weight reducing purposes. The side faces 421 of the protruding column 42 are respectively spaced from the side ends 412 of the board body 41 in a way that the inner surface 411 of the board body 41 includes two pressing portions 43 defined on two sides of the protruding column 42. Each of the pivotal strips 44 is extended outwardly from a central portion of one of the side faces 421 of the protruding column 42. In this embodiment, each of the pivotal strips 44 is inclined approximately 45 degrees relative to the inner surface 411 of the board body 41. Furthermore, each of the pivotal strips 44 includes an enlarged connecting head 45 formed on a terminal thereof. In this embodiment, the hinge connector 40 is of a one-piece construction, and each connecting head 45 has rough rectangular cross sections.

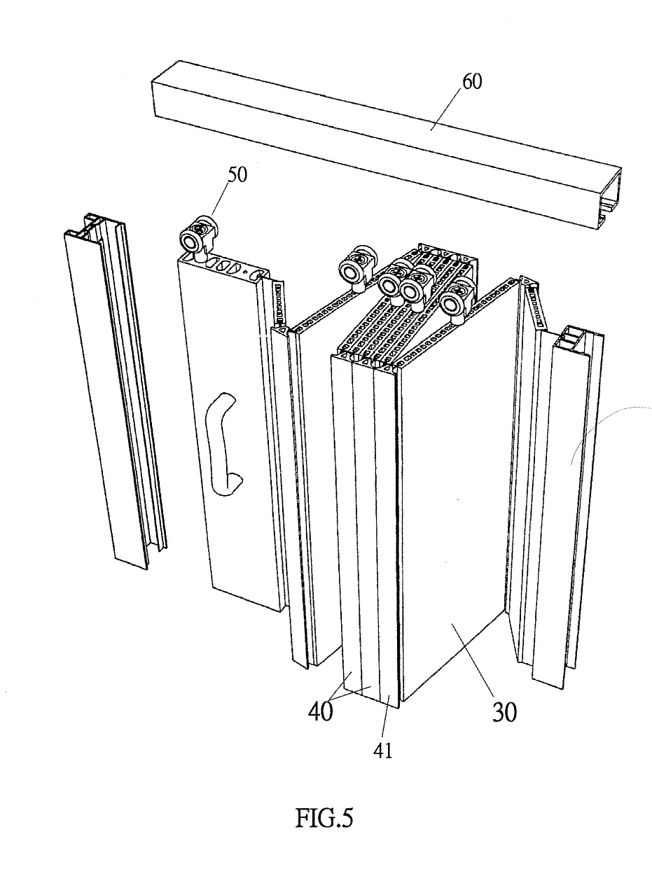

In assembling, each pivotal strip 44 of the hinge connector 40 is inserted into the opening 31 of an associated groove 32 of a corresponding door panel 30 via the upper or lower end of the door panel 30, with the connecting head 45 of each pivotal strip 44 engaged in the associated groove 32 of the corresponding door panel 30, so that the door panels 30 can utilize the flexible pivotal strips 44 as the pivotal shafts, allowing the door panels 30 can be freely folded relative to each other. FIG. 5 shows the way of using a plurality of hinge connectors 40 for connecting a plurality of door panels 30 to form a foldable door. FIG. 5 also shows the foldable door is embodied by pivotally connecting a hanging wheel 50 on an upper end of each door panel 30 so that the door panels 30 can be suspended from a slide rail 60 in order to slide along the slide rail 60.

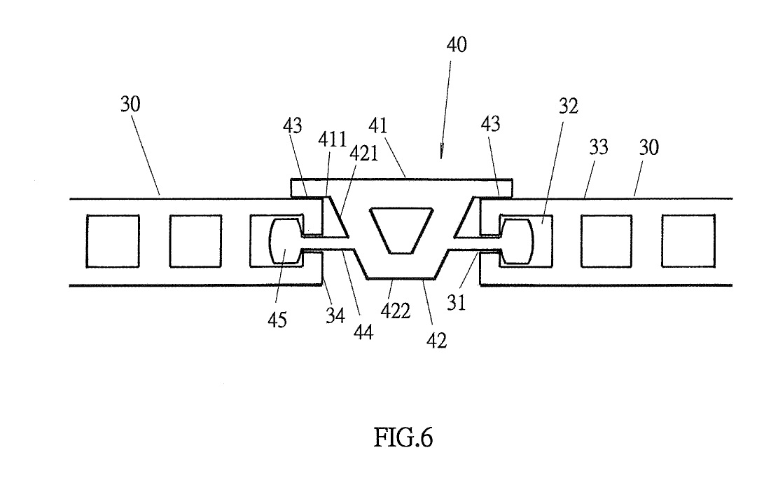

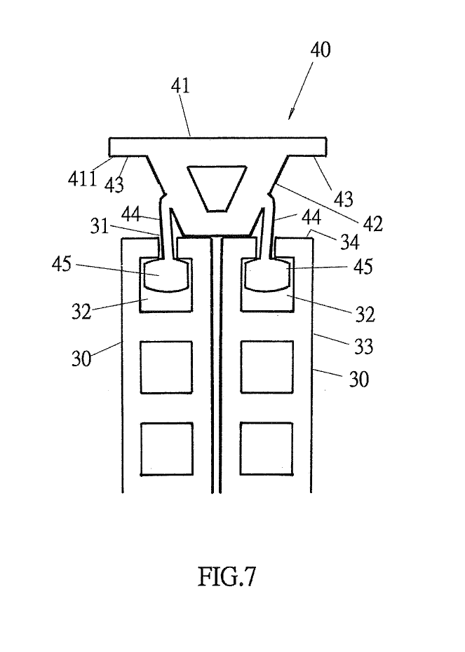

FIG. 6 shows when the door panels 30 of the foldable door are unfolded, the two door panels 30 are pivotally moved toward the board body 41 with the pivotal strips 44 of the hinge connector 40 being bent toward the board body 41, so that outer surfaces 33 of the door panels 30 are pressed and positioned against the pressing portions 43 of the hinge connector 40 respectively, and each pivotal strip 44 is roughly parallel to the inner surface 411 of the board body 41. FIG. 7 shows when the door panels 30 of the foldable door are folded, the two door panels 30 are moved further away from the board body 41 with the pivotal strips 44 of the hinge connector 40 being bent away from the board body 41, so that inner ends 34 of the two door panels 30 are pressed and positioned against the inner end face 422 of the protruding column 42 respectively, and each of the pivotal strips 44 is inclined approximately 90 degrees relative to the inner surface 411 of the board body 41.

The hinge connector 40 of the present invention has the following effects:

(1) When the door panels 30 of the foldable door are unfolded, the outer surfaces 33 of the door panels 30 are pressed and positioned against the pressing portions 43 of the hinge connectors 40 respectively, so that the door panels 30 can be presented as flat surfaces without unevenness. Furthermore, the flat surfaces of the door panels 30 matched with exquisite wood grain (or other grains or patterns) sprayed on the door panels 30 can further enhance the overall quality and delicacy of the foldable door.

(2) When the door panels 30 are folded, the inner ends 34 of the door panels 30 are pressed and positioned against the inner end faces 422 of the protruding columns 42 respectively, so that the door panels 30 can be neatly and closely folded together to avoid people from knocking against the foldable door when passing through. Furthermore, when the door panels 30 of the foldable door are folded, the board bodies 41 of the hinge connectors 40 are adjacently arranged (see FIG. 5), causing the folded foldable door to present in a rectangular box shape and making the entire foldable door to look more stylish and delicate.

(3) When each door panel 30 is folded, the flexible pivotal strips 44 are used as the pivotal shafts, and therefore it is quiet without noise during the folding of the door panels 30.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A hinge connector for a foldable door, with the hinge connector adapted for connecting two adjacent door panels of the foldable door to allow the door panels to be folded or unfolded, with each door panel including a longitudinal groove with an opening formed in each of two lateral sides thereof, with the hinge connector comprising:
a board body including two spaced side ends and an inner surface;
a protruding column protruded outwardly from the inner surface of the board body and including two inwardly inclined side faces and an inner end face connecting the two side faces, with the side faces of the protruding column respectively spaced from the side ends of the board body, with the inner surface of the board body including two pressing portions defined on two sides of the protruding column; and
two flexible pivotal strips each extending outwardly from one of the side faces of the protruding column, with each of the pivotal strips including an enlarged connecting head formed on a terminal thereof,
wherein each of the pivotal strips is adapted to be engaged in the opening of an associated groove of a corresponding door panel, with the connecting head of each pivotal strip engaged in the associated groove of the corresponding door panel, with outer surfaces of the door panels pressed against the pressing portions of the hinge connector respectively when the door panels of the foldable door are unfolded, and with inner ends of the two door panels pressed against the inner end face of the protruding column respectively when the door panels of the foldable door are folded.

2. The hinge connector according to claim 1, wherein each of the pivotal strips is at an inclined angle of 30 to 60 degrees relative to the inner surface of the board body.

3. The hinge connector according to claim 2, wherein each of the pivotal strips is at an inclined angle of 45 degrees relative to the inner surface of the board body.

4. The hinge connector according to claim 2, wherein the hinge connector is of a one-piece construction, the protruding column is protruded outwardly from a central portion of the inner surface of the board body and has rough trapezoidal cross sections, and each pivotal strip is extended outwardly from a central portion of one of the side faces of the protruding column.
